(19) United States
(12) Patent Application Publication
(10) Pub. No.: US 2007/0214834 A1
(43) Pub. Date: Sep. 20, 2007

(54) Method for Producing a Hollow Cylinder From Synthetic Quartz Glass, Using a Retaining Device

(75) Inventors: Juergen Roeper, Roitzsch (DE); Diana Kueffner, Wolfen (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: Heraeus Tenevo GmbG, Hanau (DE)

(21) Appl. No.: 11/578,004

(22) PCT Filed: Apr. 6, 2005
(86) PCT No.: PCT/EP05/03604

§ 371 Date: Oct. 6, 2006

(30) Foreign Application Priority Data
Apr. 7, 2004 (DE) 10 2004 017 572.1

(51) Int. Cl. C03B 19/01

(52) U.S. Cl. 65/17.3

(57) ABSTRACT

In a known method for producing a hollow cylinder from synthetic quartz glass, a compound containing silicon is flame-hydrolyzed and SiO₂ particles are deposited in layers on a rotating carrier to produce an elongated porous soot body with a central inner bore. Said body is subjected to a dehydration treatment and is then sintered vertically in a vitrification furnace, the body being held in the vitrification furnace by a retaining device. The retaining device comprises an elongated retaining body, which contains graphite and protrudes into the inner bore of the soot body, said soot body collapsing onto the retaining body to form the quartz glass tube. The aim of the invention is to develop said method to prevent the contamination of the quartz glass tube and to optimize the service life of the retaining device and the production costs. To achieve this, the invention uses a retaining body comprising a surface coating of beta-SiC and the SiC surface coating is exposed to a passivation atmosphere at high temperature prior to the collapse of the soot body, said atmosphere containing at least one of the following substances: NO, HCl, Cl₂ or CO.

The present invention relates to a method for producing a quartz glass tube in that a tubular porous soot body with a central inner bore is produced by depositing SiO₂ particles onto a cylindrical outer surface of a support rotating about its longitudinal axis, said body is subjected to a dehydration treatment and is subsequently sintered and collapsed, the soot body being held in a vitrification furnace by means of a holding device which comprises an elongated, graphite-containing holding body which projects into the inner bore of the soot body and onto which the soot body is collapsed with formation of the quartz glass tube.

Hollow cylinders of synthetic quartz glass are used as intermediate products for a multiplicity of components for the optical and chemical industry and particularly for producing preforms for optical fibers.

When a tubular soot body is produced according to the “OVD (outside vapor deposition) method”, fine SiO₂ particles are formed by flame hydrolysis of SiCl₄ and deposited layer by layer onto a support rotating about its longitudinal axis. Such a method is e.g. described in EP 701 975 A1. For sintering and collapsing (also called “vitrification”) the tubular soot body is held in vertical orientation in a vitrification furnace by means of a holding device which comprises a holding rod which extends from above through the inner bore of the soot body and is connected to a pedestal on which the soot body is standing with its lower face end. The holding rod consists of carbon fiber-reinforced graphite (CFC) and it is over-clad in the area of the inner bore of the soot body by a gas-permeable cladding tube of pure graphite. The cladding tube serves as a spacer during collapsing of the soot body, so that, independently of the outer diameter of the holding rod, it is possible to produce hollow cylinders of different inner diameters by varying the thickness of the cladding tube.

During vitrification of the soot body, said body collapses onto the cladding tube of graphite. In this process, impurities that are contained in the graphite, particularly metallic impurities, may get dissolved and transported into the quartz glass of the soot body. In this process a dehydration treatment of the soot body, which normally precedes vitrification and is carried out in a chlorine-containing atmosphere, plays an essential role. Impurities may here be transported out of the cladding tube into the soot body, such transportation being promoted by the presence of chlorine and the formation of volatile chlorine compounds.

Therefore, in the known method the purity of the hollow cylinder to be achieved is limited by the contamination content of the cladding tube of graphite.

After vitrification the cladding tube is removed in the known method and the inner bore of the quartz glass tube is removed by drilling, grinding, honing or etching. This method is time-consuming and leads to losses of material.

During repeated use of such a holding device, the graphite parts are subject to progressive corrosive wear. The binder embedded between the individual graphite particles is here primarily destroyed successively, for instance, by reaction with chlorine, fluorine, or oxygen, which escape from the open-pored soot body during a hot process. This process is visually expressed by an increase in the surface roughness of the respective component. This results in two considerable drawbacks. Firstly, the corrosive destruction of the graphite matrix in the high-temperature process leads to the release of impurities from the graphite, e.g. in the form of volatile metal halide compounds which, in turn, contaminate the SiO₂ soot body through the gas phase. Secondly, the inner bore of the soot body which in the collapsing process collapses onto the corroded graphite surface assumes the surface texture thereof, which requires a troublesome mechanical finishing operation.

Some of these drawbacks are avoided by the method that is known from U.S. Pat. No. 5,076,824 A and used for vitrifying a tubular soot body. Fluorine-containing SiO₂ soot is here deposited onto a support of graphite which is rotating about its longitudinal axis, said support being provided with a layer of pyrolytically produced graphite or pyrolytically produced boron nitride. During subsequent sintering of the tubular soot body in a fluorine-containing atmosphere, the same support serves to hold the soot tube in vertical orientation in a vitrification furnace, with the soot tube standing with its bottom side on a pedestal. The pedestal is here connected to the support which extends through the bore of the soot tube upwards. The pedestal is also coated with a pyrolytically produced graphite or boron nitride.

The diffusion tightness of such coatings is low, so that impurities may pass from the coated material into the soot body. Moreover, coatings of boron nitride are comparatively expensive.

It is therefore the object of the present invention to provide a method for producing a quartz glass tube using a graphite-containing holding device, which method avoids contamination of the quartz glass tube on the one hand and which is optimized with respect to the service life of the holding device and the costs spent on its production on the other hand.

Starting from the aforementioned method, this object is achieved according to the invention in that a holding body is used which comprises a surface layer of SiC, and that prior to collapsing of the soot body the SiC surface layer is exposed at a high temperature to a passivation atmosphere which contains at least one of the substances NO, HCl, Cl₂ or CO.

In a modification of the known method according to the invention, the soot body is held during sintering and collapsing by means of a holding device which comprises a surface layer of SiC.

It is described in the above-mentioned U.S. Pat. No. 5,076,824 A1 that holding members with a coating of SiC are per se inappropriate because at elevated temperatures and upon contact with quartz glass a chemical reaction takes place, as a result of which the collapsed quartz glass gets damaged and the corresponding holding device corroded. That is why U.S. Pat. No. 5,076,824A1 does not recommend such coatings as holding supports of SiO₂ soot bodies in the vitrification step. The inventors, however, have looked for a possibility how despite the above-mentioned drawback during direct contact with quartz glass a coating of SiC that is less expensive and tighter in comparison with boron nitride or pyrolytically produced graphite can be used on a holding body.

Information in this respect can be found in W. Hertel, W. W. Pultz, Trans. Faraday Soc. 62, 3440 (1968). It is reported there that in the presence of gases such as NO, HCl, Cl₂ and CO a decrease in the reaction speed between SiC and SiO₂ was observed.

In consideration of this finding a method is therefore suggested in accordance with the present invention, in which the reaction of the SiC surface layer with SiO₂ can be avoided by combining selected material and process parameters. To this end a surface layer of SiC is produced having a permeability to helium below 1×10⁻⁸ mbar x s⁻¹ on the one hand, and prior to contact with quartz glass said layer is exposed to an atmosphere containing at least one of the gases Nl, HCL, Cl₂ or CO on the other hand.

It has been found that chemisorption of said gases on the SiC surface layer takes place, which effects a passivation of the SiC layer lasting for some time, which during later contact with the collapsing quartz glass prevents reaction with the SiO₂ or at least considerably reduces such a reaction.

Hence, the method of the invention is a two-stage method, wherein the SiC surface layer is first passivated at a high temperature, and it is at best thereafter, namely on the sufficiently passivated SiC surface layer that contact is established with the collapsing quartz glass.

An adequately passivated, tight and pore-free SiC surface layer turns out to be stable under the process conditions and it shields the soot body and the furnace atmosphere on the whole against the comparatively contaminated graphite of the holding body. Apart from the holding body, the SiC surface layer may also be provided on other graphite-containing parts of the holding device.

It has been found that the passivated SiC surface of the holding body can be easily separated from the collapsed quartz glass, the state of the SiC surface largely corresponding to its initial state after this process. Due to its low corrosive wear, a correspondingly SiC-coated holding body which is passivated each time can be used repeatedly without any considerable deterioration of the surface quality of the inner bore being detected in the collapsed quartz glass tubes.

The above-described holder of the soot body is used in each heating process or in individual ones of the successive heating processes. The dehydration treatment of the soot body is normally carried out in a halogen-containing atmosphere, particularly in a fluorine- or chlorine-containing atmosphere, in a dehydration furnace. In a subsequent doping process for introducing a dopant into the soot body, the soot body is held by means of the holding device in a doping furnace. Doping may also be accompanied by the dehydration of the soot body if the dehydration atmosphere has added thereto a dopant (such as fluorine). Furthermore, in a vitrification process for sintering and collapsing the soot body, said body may be held by means of the holding device in a vitrification furnace. The use of the same furnace for dehydration, doping and/or vitrification is not ruled out. Attention must here be paid that passivation is completed before contact is established between the collapsing quartz glass and the SiC surface layer.

The holding body consists of a material which is dimensionally stable at the vitrification temperature for quartz glass. Moreover, a great breaking strength and a high thermal shock resistance contribute to the operational safety. The holding body comprises a rod or a tube. The rod or tube is either made integral or composed of a plurality of segments or pieces. The holding body may also comprise a cladding tube which surrounds the rod or tube. Graphite or CFC is particularly envisaged as a suitable material.

It has turned out to be advantageous when the SiC surface layer has a surface temperature of less than 1350° C., preferably a surface temperature of less than 1300° C., during collapsing of the soot body.

A surface temperature that is as low as possible during first contact between the collapsing quartz glass and the SiC surface layer additionally contributes to a low corrosion of the SiC layer and also to a minor wetting of the materials that are in contact with one another. As a rule, the surface shows the maximum temperature at the time of collapse of the quartz glass. To sinter and collapse quartz glass that has been produced by flame hydrolysis of silicon-containing compounds, the above-mentioned upper temperature limits of 1350° C. and 1300° C., respectively, are particularly low.

During sintering and collapsing the soot body is either completely introduced into a heating zone formed inside the vitrification furnace, and is simultaneously heated therein over its whole length, or the soot body is supplied to the heating zone, starting with one end, and is heated therein zonewise, which is here the preferred procedure. In this process, the SiC surface layer is heated zonewise to a maximum temperature during collapsing of the soot body, each location of the SiC surface layer being kept at the maximum temperature for a period of time of less than 200 minutes, preferably less than 150 minutes.

In this process the soot body is softened zonewise while being collapsed onto the holding body. The zonewise sintering and collapsing method ensures that each location of the SiC surface layer is kept at the maximum temperature only for a short period of time of the whole collapsing process. This further reduces the corrosion of the SiC surface layer.

It has turned out to be particularly useful when passivation is carried out by heating the SiC surface layer to a temperature of 800° C. or more.

At a temperature lower than 800° C., passivation of the SiC surface layer turns out to be inadequate or it requires an inefficiently long period of time.

It has also turned out to be advantageous when the soot body contains Cl₂ or HCl during sintering.

These substances may still be present e.g. as residual amounts of a preceding dehydration or passivation treatment in the soot body. They contribute to a further or renewed passivation of the SiC surface during the collapsing step.

An SiC surface layer which has been produced by means of a CVD method and which essentially consists of beta-SiC has turned out to be particularly useful.

A layer which has been produced by way of a CVD method and consists of beta-SiC is distinguished by high tightness and gas impermeability and by low roughness. As for the qualification of the SiC surface layer for the above-explained purpose, it has turned out to be advantageous when the SiC is present at least for its predominant volume portion in its beta-phase. beta-SiC shows a cubic crystal structure that is also known under the name zinc blende structure. The permeability of such a layer to helium is below 1×10-⁸ mbar x s⁻¹. In its hexagonal structure, which is also known under the name Wurzit structure, silicon carbide is called “alpha-SiC”.

The low roughness of the surface layer produced by way of a CVD method entails a small size of the contact surface between SiC and quartz glass, thereby reducing the reactivity of the SiC layer.

In this context it has turned out to be particularly advantageous when the SiC layer has an average roughness Rₐ of less than 3 μm.

The thickness of the SiC surface layer is preferably in the range between 50 μm and 150 μm.

The said range is obtained as a compromise between an adequate mechanical is strength, tightness and service life of the layer on the one hand and the efforts for producing the layer on the other hand.

The invention shall now be explained in more detail with reference to an embodiment and a drawing. As the sole figure of the drawing, and in a schematic illustration,

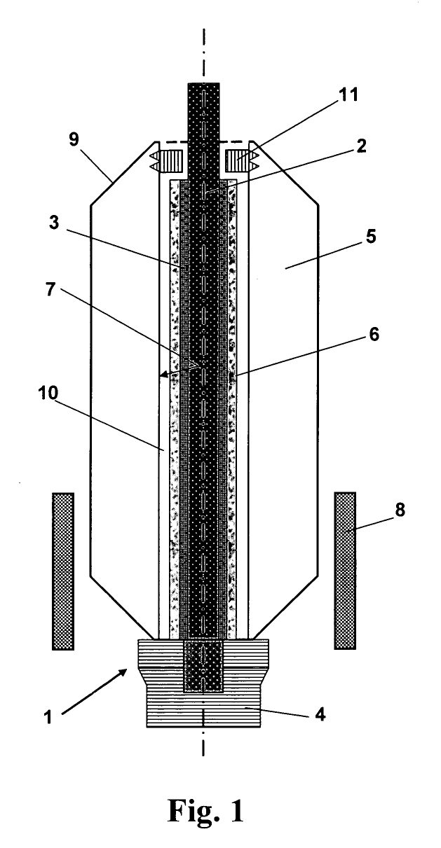

FIG. 1 shows a soot body during sintering and collapsing, the soot body being held by means of a holding device in a vitrification furnace.

The holding device according to FIG. 1 has assigned thereto reference numeral 1 on the whole. The device comprises a support rod 2 of CFC which is surrounded by a graphite tube 3 and is secured to a pedestal 4 of graphite.

The graphite tube 2 is provided over its length with a tight surface layer 6 of beta-SiC, the layer being of uniform thickness and having a permeability to helium below 1×10⁻⁸ mbar x s⁻¹. The thickness of the SiC surface layer 6 is about 100 μm and its average surface roughness is not more than 2 μm (Rₐ value). The SiC surface layer 6, which for reasons of illustration is shown in FIG. 1 with an exaggerated thickness, prevents direct contact between the graphite of tube 3 and the soot tube 5, while shielding the furnace atmosphere on the whole against contamination from the graphite. As a consequence, the SiC surface layer 6 also reduces the risk of contamination of the soot tube 5 by gaseous impurities diffusing out of the support rod 2 or the graphite tube 3.

The definition of the surface roughness Rₐ follows from EN ISO 4287, the measuring conditions from EN ISO 4288 or EN ISO 3274, depending on whether the SiC surface of the measurement sample has an aperiodic surface profile (as in the instant case) or a periodic surface profile.

Pedestal 4 is provided with a horizontally oriented accommodating surface on which a tubular soot body (soot tube 5) of SiO₂ is seated in vertical orientation. Pedestal 4 and support rod 2 are firmly interconnected by means of a thread. The pedestal 4 serves to accommodate the arrangement of support rod 2 and soot tube 5 in a dehydration furnace and in a doping and vitrification furnace, each being symbolized in FIG. 1 by an annular heating element 8.

The support rod 2 extends through the whole inner bore 7 of the soot tube 5. The part of the support rod 2 that projects beyond the upper end 9 of the soot tube 5 serves handling purposes. On account of its high tensile strength a relatively small diameter of the CFC support rod 2 of 30 mm is sufficient.

A gap 10 having a mean gap width of 2 mm remains between the SiC-coated graphite tube 3 and the inner wall of the soot tube 5.

The soot tube 5 has an inner diameter of 43 mm and a weight of about 100 kg. It can be transported by means of the holding device 1 and held in the respective treatment chamber (dehydration, doping and vitrification furnace).

An embodiment of the method of the invention for producing a tube of synthetic quartz glass using the holding device 1 shown in FIG. 1 shall now be described in more detail in the following:

SiO₂ soot particles are formed by flame hydrolysis of SiCl₄ in the burner flame of a deposition burner and are deposited layer by layer on a support rod of Al₂O₃ which is rotating about its longitudinal axis, with formation of a soot body of porous SiO₂. After the deposition method has been completed, the support rod is removed. With the method that will be explained in the following by way of example, a transparent quartz glass tube is produced from the soot body 5 obtained in this way, which has a density about 25% the density of quartz glass:

The soot tube 5 is subjected to a dehydration treatment-for removing the hydroxyl groups introduced by the production process. To this end the soot tube 5 is introduced into a dehydration furnace and held therein in vertical orientation by means of the holding device 1. The soot tube 5 is first treated in a chlorine-containing atmosphere at a temperature around 900° C. The treatment lasts for about eight hours. The treatment in a chlorine-containing atmosphere leads to chemisorption of chlorine atoms or molecules on the SiC surface layer 6, thereby effecting a passivation relative to the reaction with SiO₂, the effect of which will be described in more detail further below.

The soot tube 5 which has been pretreated in this way is subsequently introduced by means of the holding device 1 into a vitrification furnace with a vertically oriented longitudinal axis. The vitrification furnace is evacuable and equipped with the annular heating element 8 of graphite, which is also provided with a surface layer of beta-SiC. Particularly during operation of the furnace without vacuum, the coating of the heating element shows advantages in keeping the furnace chamber clean; not so much during vacuum operation. Starting with is lower end, the soot tube 5 is continuously fed from above to the heating element 8 at a feed rate of 10 mm/min and is heated therein zonewise. The temperature of the heating element 8 is preset to 1400° C., resulting in a maximum temperature of about 1300° C. on the surface of the SiC surface layer 6. During sintering and collapsing of the soot tube 5 a melt front is traveling inside the soot tube 5 from the outside to the inside and at the same time from the top to the bottom. During vitrification the internal pressure inside the vitrification furnace is kept by continuous evacuation at 0.1 mbar. During vitrification the soot tube 5 will shrink onto the SiC-coated graphite tube 3 zone by zone. Gases that escape during sintering and collapsing are discharged through the still open-pored area of the soot tube 5 and through the still open part of the gap 10 between graphite tube 3 and soot tube 5, whereby the formation of bubbles is prevented. In the course of the vitrification process a holding nut 11 that is screwed into the soot body 5 comes to rest on the upper end of the graphite tube 3, so that the further vitrification process will subsequently be performed with a suspended soot body (5), as described in EP 701 975 A1.

The support rod 2 and the SiC-coated graphite tube 3 are removed from the bore of the quartz glass tube obtained in this way by sintering and collapsing. It has been found that the inner surface of the quartz glass tube is planar and clean, so lo that a mechanical finishing treatment is not required. The SiC coating does also not show any visually discernible corrosion. A checking of the purity of the contact surface relative to the SiC surface layer 6 revealed much lower contamination contents than in the case of a contact surface with the non-coated graphite tube 3.

In a final step, the quartz glass tube is elongated to an outer diameter of 46 mm and an inner diameter of 17 mm. The resulting quartz glass tube shows high purity and minor amounts of impurities, which permits an application in the near-core area of a preform for optical fibers, for instance as a substrate tube for inside deposition by means of the MCVD method. The quartz glass tube is of course also suited for overcladding a core rod during fiber drawing or for the production of a preform.

1. A method for producing a quartz glass tube, said method comprising:
producing a tubular porous soot body including a central inner bore by depositing SiO₂ particles onto a cylindrical outer surface of a support rotating about a longitudinal axis thereof;
subjecting said soot body to a dehydration treatment and subsequently sintering and collapsing the soot body;
the soot body being held in a vitrification furnace by means of a holding device comprising an elongated, graphite-containing holding body onto which the soot body is collapsed so as to form the quartz glass tube, the holding body projecting into the inner bore of the soot body, wherein the holding body comprises a surface layer of SiC, and wherein prior to the collapsing of the soot body the SiC surface layer is exposed at a high temperature to a passivation atmosphere which contains at least one substance selected from the group consisting of NO, HCl, Cl₂ and CO.

2. The method according to claim 1, wherein during collapsing of the soot body the SiC surface layer has a surface temperature of less than 1350° C.

3. The method according to claim 2, wherein during the collapsing of the soot body the SiC surface layer is heated zonewise to a maximum temperature, wherein each location of the SiC surface layer is held at the maximum temperature for a period of time of less than 200 minutes.

4. The method according claim 1, wherein the SiC surface layer is heated to a temperature of 800° C. or higher during the exposure to the passivation atmosphere.

5. The method according to claim 1, wherein the soot body contains Cl₂ or HCl during sintering.

6. The method according to claim 1, wherein the SiC surface layer consists essentially of beta-SiC and is produced by means of CVD.

7. The method according to claim 1, wherein the thickness of the SiC surface layer is in a range between 50 μm and 150 μm.

8. The method according to claim 1, wherein the SiC surface layer has an average roughness Rₐ of less than 3 μm.

9. The method according to claim 1, wherein during the collapsing of the soot body the SiC surface layer has a surface temperature of less than 1300° C.

10. The method according to claim 2, wherein during the collapsing of the soot body the SiC surface layer is heated zonewise to a maximum temperature, wherein each location of the SiC surface layer is held at the maximum temperature for a period of time of less than 150 minutes.
